(19) United States
(12) Patent Application Publication
(10) Pub. No.: US 2004/0247294 A1
(43) Pub. Date: Dec. 9, 2004

(54) Information storage medium storing moving picture data and additional data, reproducing apparatus and method therefor

(75) Inventors: Kil-soo Jung, Gyeonggi-do (KR); Seong-jin Moon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/804,188

(22) Filed: Mar. 19, 2004

(30) Foreign Application Priority Data
Mar. 22, 2003 (KR) 2003-17976

(51) Int. Cl. H04N 5/781

(52) U.S. Cl. 386/95; 386/125

(57) ABSTRACT

An information storage medium storing moving picture data and additional data, a reproducing apparatus and method therefor. The information storage medium stores core mode data which includes moving picture data having coded stream data of moving pictures and navigation data controlling playback of the moving picture data, full mode data which includes browser mode data made using a markup language and an execution script and/or program mode data made using a program language, and startup data which includes data designating mode data to be initially reproduced among the core mode data, the browser mode data, and the program mode data.

### CROSS-REFERENCE TO RELATED APPLICATIONS

This application claims the priority of Korean Patent Application No. 2003-17976, filed on Mar. 22, 2003, in the Korean Intellectual Property Office, the disclosure of which is incorporated herein by reference.

### BACKGROUND OF THE INVENTION

1. Field of the Invention

The present invention relates to moving picture data and technology of reproducing the moving picture data, and more particularly, to an information storage medium storing moving picture data and additional data performing interaction with a user and a browsing function, a reproducing apparatus and method therefor.

2. Description of the Related Art

Moving picture data stored in a digital versatile disc (DVD) typically includes an audio/video (AV) stream for playing a movie and navigation data for navigating the movie. In reproducing moving pictures, demands on an application based on a program enhancing interaction with a user and an application including a browsing function considering a network environment have been increased.

### SUMMARY OF THE INVENTION

The present invention provides an information storage medium storing moving picture data and additional data performing interactions with a user and a browsing function, a reproducing apparatus and method therefor.

The present invention provides an information storage medium storing moving picture data, navigation data for reproducing moving pictures, and additional data enhancing a program function and a browsing function, a reproducing apparatus and method therefor.

The present invention provides an information storage medium storing moving picture data, navigation data for reproducing moving pictures, and additional data providing a browsing function for a web service and various contents and a program based interactive function, and a reproducing apparatus and method therefor.

According to an aspect of the present invention, there is provided an information storage medium storing core mode data which includes moving picture data, including coded stream data of moving pictures, and navigation data controlling playback of the moving picture data; full mode data which includes browser mode data made using a markup language and an execution script and/or program mode data made using a program language; and startup data which includes data designating mode data to be initially reproduced among the core mode data, the browser mode data, and the program mode data.

Additional aspects and/or advantages of the invention will be set forth in part in the description which follows and, in part, will be obvious from the description, or may be learned by practice of the invention.

According to another aspect of the present invention, there is provided a reproducing apparatus for an information storage medium storing multimedia data which includes core mode data and startup data or core mode data, startup data and full mode data, the full mode data including at least one among browser mode data and program mode data. The reproducing apparatus includes a reader which read data from the information storage medium; a presentation engine which decodes and reproduces moving picture stream data read by the reader; a navigation engine which processes navigation data for reproducing the moving picture stream data read by the reader; a browser engine which processes the browser mode data read by the reader; a program engine which executes the program mode data read by the reader; an application manager which determines mode data to be initially reproduced according to the startup data read by the reader, controls an engine corresponding to the determined mode data, and performs mode transition; and a blender which blends an output of the presentation engine and at least one of an output of the browser engine and an output of the program engine into a single output.

According to still another aspect of the present invention, there is provided a reproducing apparatus for an information storage medium storing multimedia data including core mode data and startup data or core mode data, startup data and full mode data. The reproducing apparatus includes a reader which reads data from the information storage medium; a presentation engine which decodes and reproduces moving picture stream data read by the reader; and a navigation engine which processes navigation data for reproducing the moving picture stream data read by the reader. Here, the presentation engine reproduces only the core mode data designated by the startup data.

According to still another aspect of the present invention, there is provided a reproducing method for an information storage medium storing multimedia data comprising core mode data and startup data or core mode data, startup data and full mode data. The reproducing method comprises setting one mode among a core mode and a full mode according to the startup data designating mode data to be initially reproduced among the core mode data and the full mode data; and reproducing the core mode data or the full mode data according to the set mode.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates types of data stored in an information storage medium according to an embodiment of the present invention;

FIG. 2 is a schematic diagram of a reproducing apparatus model according to an embodiment of the present invention;

FIG. 3 is a schematic diagram of a reproducing apparatus model for both of a core mode and a full mode, according to an embodiment of the present invention;

FIG. 4 is a block diagram of a reproducing apparatus for both of the core mode and the full mode, according to an embodiment of the present invention; and

FIG. 5 is a block diagram of a reproducing apparatus for the core mode, according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The following data is stored on an information storage medium according to the present invention to fundamentally reproduce moving picture data and implement interaction with a user and a browsing function: 1) moving picture data which is recorded after being coded using a Moving Picture Experts Group (MPEG) coding method; 2) data related to navigation for reproducing the moving picture data; 3) data related to a program based interactive function; 4) data related to a markup language based browsing function; 5) information data including various properties of the moving picture data and audio data; 6) startup data for initially executing stored data; and 7) an Application Program Interface (API) controlling the moving picture data in the program based interactive function and the markup language based browsing function.

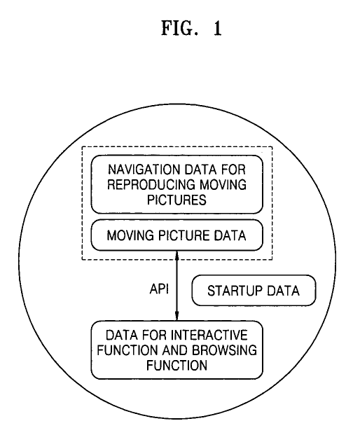

FIG. 1 illustrates types of data stored in an information storage medium according to an embodiment of the present invention. Referring to FIG. 1, moving picture data, navigation data for reproducing moving pictures, data for an interactive function and a browsing function, and startup data designating the data to be used when the information storage medium is initially played by a reproducing apparatus are stored in the information storage medium. The data for the interactive function and the browsing function includes an API controlling the moving picture data. The moving picture data and the navigation data are referred to as core data or core mode data. The core mode is referred to as a movie mode in which a movie is reproduced from, for example, a representative video application, i.e., a digital versatile disc (DVD), using data comprising a set of navigation commands navigating the moving picture data. Data for a program based interactive function and a browsing function is referred to as full data or full mode data. There are usually two types of reproducing apparatuses: a first type of reproducing apparatus that can reproduce only core mode data; and a second type of reproducing apparatus that can reproduce both core mode data and full mode data.

In an embodiment of the present invention, the moving picture data includes a data file for video and audio encoded using an MPEG2 method and for a subtitle, a still picture stream and/or a data file comprising still picture images that can be present in the form of an MPEG2 stream or in the form of a set of Joint Photographic Experts Group (JPEG) files. The moving picture data also includes additional information including coding properties of the various types of streams and/or data files and an entry point for random access, and a playlist formed by arranging a playback order of moving picture streams or still picture streams and making the playback order into an object. The playlist may be referred to as playback unit data that defines units in which moving picture stream data is reproduced.

The navigation data for reproducing moving pictures is usually stored in the form of a table of binary codes and comprises commands reproducing or jumping to a playlist. These commands are referred to as navigation commands. The moving picture data is used in a movie mode and also used in a program mode and a browser mode when data, e.g., European Computer Manufacturers' Association (ECMA) script, for the browser mode and data, e.g., a Java program, for the program mode include an API function that reproduces a playback object, i.e., a playlist, to control playback of the moving picture data.

The startup data designates mode data to be initially reproduced when the information storage medium storing movie (core) data, browser mode data, and program mode data is played by a reproducing apparatus. After the data designated by the startup data is reproduced, an operation is performed according to the reproduced data. In addition, the startup data includes link information needed for a mode change, for example, from the core mode to the browser mode or from the browser mode to the program mode.

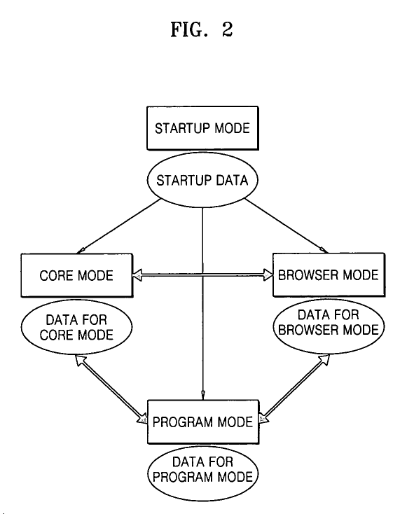

FIG. 2 is a schematic diagram of a reproducing apparatus model according to an embodiment of the present invention. Referring to FIG. 2, when an information storage medium according to an embodiment of the present invention is played by a reproducing apparatus, a startup data file is read during an initial access of the reproducing apparatus, which can be referred to as a startup mode. In the startup mode, the startup data file is read from the information storage medium and analyzed, thereby designating a position of data to be initially reproduced. For example, when movie mode data is to be reproduced initially, a navigation command designating a playlist number corresponding to a playback object to be initially reproduced is used to designate data to be initially reproduced. When browser mode data is to be initially reproduced, a page unit that includes a variety of resources referred to by a markup document and is shown on a single screen is used. When program mode data is to be initially reproduced, a program unit implemented by a single Java application is used. In other words, when a reproducing apparatus plays an information storage medium storing data for an interactive function and a browsing function as well as data for reproducing moving pictures, the reproducing apparatus initially reproduces mode data designated by the startup data from the information storage medium among various mode data stored in the information storage medium.

Referring to FIG. 2, even when playback starts in a particular mode, mode transition is possible. Mode transition is executed not by a user's option but by a command, which is composed during manufacturing of the information storage medium to change a particular mode into another mode, or by intervention of an application manager when data for a particular mode includes a link to data for another mode. Here, each mode data may include a link to other data corresponding to the current mode or data corresponding to a different mode. For example, the core mode data may include a link to a specific playlist in the core mode data or may include a link to the program mode data.

However, a reproducing apparatus that can reproduce only core mode data cannot continue playback at a point where mode transition is made to reproduce full mode data. In particular, when startup data stored in an information storage medium designates the full mode data, the information storage medium cannot be played by the reproducing apparatus from the beginning.

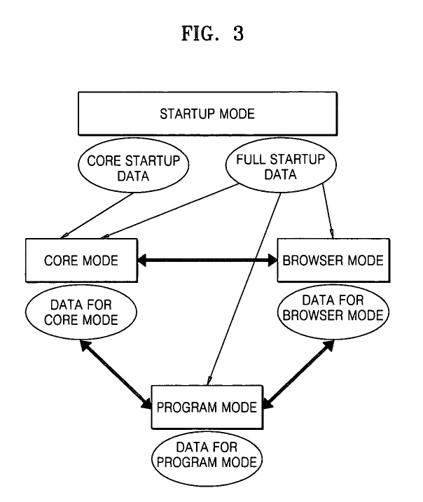

FIG. 3 is a schematic diagram of a reproducing apparatus model for both the core mode and the full mode, according to an embodiment of the present invention. To solve the above-described and/or other problems, two startup data files are stored on the information storage medium.

Referring to FIG. 3, core startup data and full startup data are present in the startup mode. The full startup data is the same as the startup data described with reference to FIG. 2. The core startup data is startup data only for the core mode. For example, when an information storage medium storing core mode data, browser mode data, and program mode data is played by a reproducing apparatus that is only for the core mode, i.e., the reproducing apparatus can reproduce only a movie, and only a single startup data file is present in the form shown in FIG. 2 and the startup data file designates full mode data, the information storage medium cannot be played by the reproducing apparatus that is only for the core mode.

However, if the core startup data only for the movie mode is additionally stored in the information storage medium, the reproducing apparatus that is only for the core mode can reproduce the core mode data from the information storage medium using the core startup data. In this case, the core mode data does not include data for mode transition.

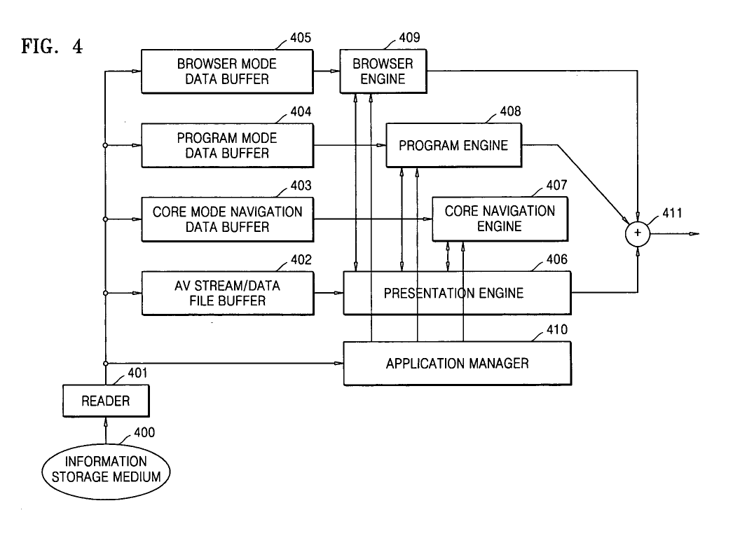

FIG. 4 is a block diagram of a reproducing apparatus for both the core mode and the full mode, according to an embodiment of the present invention. The reproducing apparatus shown in FIG. 4 can play both the core mode data and the full mode data shown in FIGS. 2 and 3.

Referring to FIG. 4, the reproducing apparatus displays moving picture streams and still picture streams and/or data files stored in an information storage medium 400 according to a display method using particular mode data. The reproducing apparatus includes a reader 401, an audio and video (AV) stream/data file buffer 402 buffering moving pictures and still pictures, a core mode navigation data buffer 403, a program mode data buffer 404, a browser mode data buffer 405, a presentation engine 406, a core navigation engine 407, a program engine 408, a browser engine 409, an application manager 410, and a blender 411.

The reader 401 reads an AV stream and/or a data file for moving pictures and still pictures, core mode navigation data, program mode data, browser mode data, and startup data from the information storage medium 400. Each of the buffers 402 through 405 buffers corresponding data among the read data, and then each of the engines 406 through 409 reproduces corresponding data among the buffered data. Meanwhile, the startup data is transmitted to the application manager 410 so that the mode data to be initially reproduced is determined. The application manager 410 includes a user input receiver and a user input processor to process a user's input and transmit the user's input to an engine for a mode corresponding to the user's input among the engines 406 through 409. The presentation engine 406 decodes and reproduces the AV stream and/or data file. The core navigation engine 407, the program engine 408, and the browser engine 409 controls the presentation engine 406 via an API.

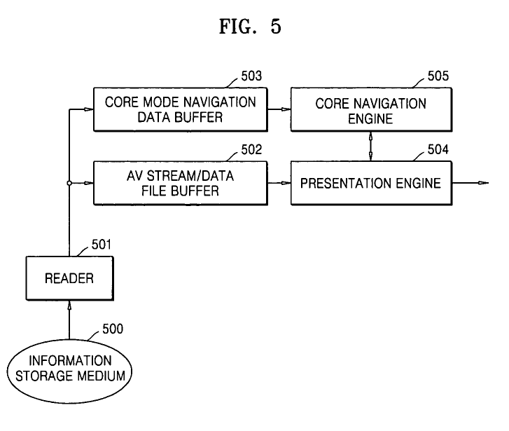

FIG. 5 is a block diagram of a reproducing apparatus for the core mode, according to an embodiment of the present invention. The reproducing apparatus shown in FIG. 5 includes only a block for processing core mode data among the structure of the reproducing apparatus shown in FIG. 4. The reproducing apparatus shown in FIG. 5 includes a reader 501, an AV stream/data file buffer 502, a core mode navigation data buffer 503, a presentation engine 504, and a core navigation engine 505.

Referring to FIG. 5, the reader 501 reads an AV stream and/or a data file for moving pictures and still pictures and core mode navigation data from the information storage medium 500 and writes them to the buffers 502 and 503, respectively. The presentation engine 504 decodes and reproduces the AV stream and/or data file, and the core navigation engine 505 reproduces the core mode navigation data. In other words, the core navigation engine 505 transmits a set of navigation commands present in the core mode data to the presentation engine 504 so that playback starts in the core mode.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, the present invention provides improved playback of moving picture data, enhanced interaction with a user, and various additional information data, thereby increasing diversity and a user's convenience.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium, comprising:
core mode data which comprises moving picture data, comprising coded stream data of moving pictures, and navigation data controlling playback of the moving picture data;
full mode data which comprises browser mode data made using a markup language and an execution script and/or program mode data made using a program language; and
startup data which comprises data designating one of the mode data to be initially reproduced among the core mode data, the browser mode data, and the program mode data.

2. The information storage medium of claim 1, wherein each of the core mode data, the browser mode data and the program mode data comprises a link to another one of the mode data corresponding to a current mode or a different mode.

3. The information storage medium of claim 2, wherein after the mode data to be initially reproduced is determined according to the startup data, a reproducing apparatus operates according to the determined mode data, and the startup data comprises link information so that a mode transition is executable during playback.

4. The information storage medium of claim 1, wherein the moving picture data further comprises playback unit data defining playback units in which the moving picture data is reproduced, and at least one among the navigation data, the browser mode data, and the program mode data comprises an Application Program Interface (API) reproducing the playback units.

5. The information storage medium of claim 4, wherein the startup data designates one among the core mode data, the browser mode data, and the program mode data.

6. The information storage medium of claim 5, wherein: when the startup data designates the core mode data, the startup data designates a first playback unit to be initially reproduced among the playback units; when the startup data designates the browser mode data, the startup data designates a file made using a markup language and an execution script; and when the startup data designates the program mode data, the startup data designates a file made using a program language.

7. The information storage medium of claim 4, wherein the startup data comprises core mode startup data and full mode startup data, the core mode startup data designating only the core mode data, the full mode startup data designating one among the core mode data, the browser mode data, and the program mode data.

8. The information storage medium of claim 7, wherein: when the full mode startup data designates the core mode data, the full mode startup data designates a first playback unit to be initially reproduced among the playback units; when the full mode startup data designates the browser mode data, the full mode startup data designates a file made using a markup language and an execution script; and when the full mode startup data designates the program mode data, the full mode startup data designates a file made using a program language.

9. A reproducing apparatus for an information storage medium storing multimedia data comprising core mode data and startup data or core mode data, startup data and full mode data, the full mode data comprising at least one among browser mode data and program mode data, the reproducing apparatus comprising:
a reader which reads data from the information storage medium;
a presentation engine which decodes and reproduces the data read by the reader corresponding to moving picture stream data;
a navigation engine which processes navigation data, in the read data, reproducing the moving picture stream data;
a browser engine which processes the data read by the reader corresponding to the browser mode data;
a program engine which executes the data read by the reader corresponding to the program mode data; an application manager which determines one of the core mode data, the browser mode data, and the program mode data to be initially reproduced according to the startup data in the data read by the reader, controls an engine corresponding to the determined one of the mode data, and performs mode transition; and
a blender which blends an output of the presentation engine and at least one among an output of the browser engine and an output of the program engine into a single output.

10. The reproducing apparatus of claim 9, wherein the application manager initially reproduces the determined one of the mode data designated by the startup data, then processes another data corresponding to a current mode or a different mode according to a link in the determined one of the mode data designated by the startup data, and performing the mode transition when necessary.

11. The reproducing apparatus of claim 10, wherein after the application manager determines the mode data to be initially reproduced according to the startup data, the application manager controls operations of the reproducing apparatus according to the determined mode data, and performs the mode transition during playback referring to link information in the startup data.

12. The reproducing apparatus of claim 9, wherein moving picture data stored in the information storage medium comprises the moving picture stream data and playback unit data defining playback units in which the moving picture stream data is reproduced;
at least one among the navigation data, the browser mode data, and the program mode data comprises an Application Program Interface (API) reproducing the playback units; and
when at least one among the navigation engine, the browser engine, and the program engine performs the API, the reproducing apparatus provides a signal controlling playback to the presentation engine to control playback of the moving picture stream data.

13. The reproducing apparatus of claim 12, wherein the startup data designates one among the core mode data, the browser mode data, and the program mode data.

14. The reproducing apparatus of claim 13, wherein when the startup data designates the core mode data, the startup data designates a first playback unit to be initially reproduced among the playback units, and the navigation engine processes the data designating the playback unit;
when the startup data designates the browser mode data, the startup data designates a file made using a markup language and an execution script, and the browser engine processes the data designating the file; and
when the startup data designates the program mode data, the startup data designates a file made using a program language, and the program engine processes the data designating the file using the program language.

15. The reproducing apparatus of claim 12, wherein the startup data comprises core mode startup data and full mode startup data, the core mode startup data designating only the core mode data, the full mode startup data designating one among the core mode data, the browser mode data, and the program mode data; and
when the full mode data is reproducible by the reproducing apparatus the reproducing apparatus initially reproduces data designated by the full mode startup data.

16. The reproducing apparatus of claim 15, wherein when the full mode startup data designates the core mode data, the full mode startup data designates a first playback unit to be initially reproduced among the playback units, and the navigation engine processes the full mode startup data designating the playback unit;
when the full mode startup data designates the browser mode data, the full mode startup data designates a file made using a markup language and an execution script, and the browser engine processes the full mode startup data designating the file; and
when the full mode startup data designates the program mode data, the full mode startup data designates a file made using a program language, and the program engine processes the full mode startup data designating the file using the program language.

17. The reproducing apparatus of claim 9, wherein the application manager comprises a user input receiver and a user input processor to process a user's input, thereby controlling one of the presentation, navigation, browser and program engines corresponding to the user's input.

18. A reproducing apparatus for an information storage medium storing multimedia data comprising core mode data, startup data and full data, the reproducing apparatus comprising:
a reader which reads data from the information storage medium;
a presentation engine which decodes and reproduces the data read by the reader corresponding to moving picture stream data; and
a navigation engine which processes navigation data in the data reproducing the moving picture stream data read by the reader,
wherein, when the information storage medium is loaded in the reproducing apparatus which is unable to recognize the full mode data, the startup data initiates reproduction of only the core mode data and the presentation engine reproduces only the core mode data designated by the startup data.

19. A reproducing method for an information storage medium storing multimedia data comprising core mode data and startup data or core mode data, startup data and full mode data, the reproducing method comprising:
setting one mode among a core mode and a full mode according to the startup data designating mode data to be initially reproduced among the core mode data and the full mode data; and
reproducing the core mode data or the full mode data according to the set mode.

20. The reproducing method of claim 19, wherein moving picture data comprising coded moving picture stream data and navigation data controlling playback of the moving picture data are reproduced in the core mode, and at least one among browser mode data made using a markup language and an execution script and program mode data made using a program language is reproduced in the full mode.

21. The reproducing method of claim 20, wherein each of the browser mode data and the program mode data comprises a link to other data corresponding to a current mode or data for a different mode, the reproducing method further comprising reading the other data corresponding to the current mode or the data corresponding to the different mode according to the link comprised in each of the mode data and changing modes when necessary.

22. The reproducing method of claim 21, wherein after the mode data to be initially reproduced is designated according to the startup data, the reproducing the core made data or the full mode data further comprises performing mode transition during playback referring to a link comprised in the startup data.

23. The reproducing method of claim 20, wherein the moving picture data further comprises playback unit data defining playback units in which the moving picture stream data is reproduced,
at least one among the navigation data, the browser mode data, and the program mode data comprises an Application Program Interface (API) reproducing the playback units, wherein
the moving picture stream data is reproduced by performing the API.

24. The reproducing method of claim 23, wherein the startup data designates one among the core mode data, the browser mode data, and the program mode data.

25. The reproducing method of claim 24, wherein when the startup data designates the core mode data, the startup data designates a playback unit to be initially reproduced among the playback units; when the startup data designates the browser mode data, the startup data designates a file made using a markup language and an execution script; and when the startup data designates the program mode data, the startup data designates a file made using a program language.

26. The reproducing method of claim 23, wherein the startup data comprises core mode startup data and full mode startup data, the core mode startup data designating only the core mode data, the full mode startup data designating one among the core mode data, the browser mode data, and the program mode data.

27. The reproducing method of claim 26, wherein when the full mode startup data designates the core mode data, the full mode startup data designates a playback unit to be initially reproduced among the playback units; when the full mode startup data designates the browser mode data, the full mode startup data designates a file made using a markup language and an execution script; and when the full mode startup data designates the program mode data, the full mode startup data designates a file made using a program language.

28. An information storage medium, comprising:
core mode data which comprises moving picture data and navigation data controlling a playback of the moving picture data in a core mode; and
full mode data comprising at least one of program mode data and browser mode data controlling at least one of a respective corresponding interactive program and browsing program, wherein the playback of the moving picture data is further controlled in response to an application program interface (API) in the at least one of the program mode data and the browser mode data.

29. The information storage medium of claim 28, further comprising:
startup data designating one of the core mode data and the full mode data to be reproduced upon initiating a reproduction of the information storage medium.

30. The information storage medium of claim 29, wherein the startup data further comprises links to the core mode data, the program mode data and the browser mode data, wherein a mode change from one of the program mode data to the core mode data to the other is carried out depending on the startup data designation.

31. The information storage medium of claim 28, further comprising:
startup data designating both the core mode data and the full mode data to be reproduced upon initiating a reproduction of the information storage medium.

32. The information storage medium of claim 31, wherein when the information storage medium is loaded in a reproducing apparatus which is unable to recognize the full mode data, the startup data initiates reproduction of only the core mode data.

33. The information storage medium of claim 32, wherein the core mode data does not comprise links corresponding to the mode change.

34. The information storage medium of claim 31, wherein when the information storage medium is loaded in a reproducing apparatus which recognizes the full mode data, the startup data selectively initiates reproduction of one of the core mode data and the full mode data prior to the other.

35. The information storage medium of claim 34, wherein the core mode data comprises links corresponding to entry points in the full mode data.

36. The information storage medium of claim 35, wherein the full mode data comprises links corresponding to entry points in the core mode data.

37. The information storage medium of claim 34, wherein the program mode data comprises links corresponding to entry points in the core mode data and the browser mode data, respectively.

38. The information storage medium of claim 34, wherein the browser mode data comprises links corresponding to entry points in the core mode data and the program mode data, respectively.

39. The information storage medium of claim 34, wherein the program mode data comprises links corresponding to entry points in the core mode data and the browser mode data, the browser mode data comprises links corresponding to entry points in the core mode data and the program mode data, and the core mode data comprises links corresponding to entry points in the program mode data and the browser mode data, wherein the respective entry points designate a portion of the corresponding one of the core mode data, the program mode data, and the browser mode data to be reproduced.

40. A reproducing apparatus using an information storage medium, comprising:
a reader which reads startup data, core mode data and full mode data from the information storage medium;
a buffer which buffers the core mode data and the full mode data; and
a reproducer which reproduces the startup data first and then reproduces the core mode data and the full mode data based on commands designating an order of reproduction of the core mode data and the full mode data.

41. The apparatus of claim 40, wherein the startup data designates only the core mode data to be reproduced first.

42. The apparatus of claim 40, wherein the startup data designates one of the core mode data and the full mode data to be reproduced first.

43. The apparatus of claim 42, wherein the full mode data comprises at least one of program data enabling interaction with a user and browsing data enabling browsing corresponding to a page unit comprising resources called by a markup document.

44. The apparatus of claim 43, wherein the reproducer comprises:
a browsing engine reproducing the browsing mode data and executing the corresponding page unit called by the markup document;
a program engine reproducing the program mode data and executing corresponding program commands;
a navigation engine reproducing and executing navigation commands in the core mode data controlling reproduction of the core mode data;
a presentation engine reproducing the core mode data in response to the navigation commands from the navigation engine; and
an application manager controlling reproduction and mode conversion of the core mode data, the browsing mode data, and the program mode data based on the reproduced navigation commands, the page units, and the program commands, wherein the application manager controls the respective corresponding engine to reproduce and execute the startup data first.

45. The apparatus of claim 44, wherein the application manager controls the reproduction and mode conversion through an application program interface (API).

46. A computer readable recording medium recording a program that executes a method of reproducing an information storage medium storing multimedia data comprising core mode data and startup data or core mode data, startup data and full mode data, wherein the method comprises:
setting one mode among a core mode and a full mode according to the startup data designating mode data to be initially reproduced among the core mode data and the full mode data; and
reproducing the core mode data or the full mode data according to the set mode.
